(19) United States
(12) Patent Application Publication
(10) Pub. No.: US 2023/0308635 A1
(43) Pub. Date: Sep. 28, 2023

(54) CIRCULAR CACHE FOR PROPAGATING BLOCK LEVEL CONTRIBUTING RELEVANCE AMOUNTS

(71) Applicant: Meta Platforms, Inc., Menlo Park, CA (US)

(72) Inventors: Handong Li, Union City, CA (US); Yunqing Chen, Los Altos, CA (US)

(21) Appl. No.: 17/351,993

(22) Filed: Jun. 18, 2021

(51) Int. Cl. H04N 19/105; H04N 19/124; H04N 19/433; H04N 19/176

(52) U.S. Cl. CPC H04N 19/105; H04N 19/124; H04N 19/433; H04N 19/176

(57) ABSTRACT

A processor includes a block relevance determination hardware unit configured to determine a corresponding degree of relevance metric for each block of pixels included in blocks of pixels of a reference frame of a video being encoded. The processor also includes a hardware circular cache configured to store groups of cache entries. Each cache entry of each group of the groups of cache entries is configured to cache at least one corresponding one of the accumulated relevance amounts for the blocks of pixels of the reference frame. The processor further includes an encoder hardware unit configured to encode the reference frame using different quantization factors determined for a different block of pixels of the reference frame based on the corresponding degree of relevance metric.

### BACKGROUND OF THE INVENTION

Digital video is often encoded using a codec to compress it into a smaller size. The goal is to most efficiently compress it with minimal loss in quality. Various different techniques can be utilized in an attempt to achieve this goal but often a large amount of computing resources is required to utilize these techniques. Using a common general purpose processor to perform video encoding may limit the techniques that can be used to achieve better results due to constraints in processing capabilities and limitations of the general purpose processor. Thus there exists a need for a more efficient and practical way to achieve better video encoding.

### BRIEF DESCRIPTION OF THE DRAWINGS

Various embodiments of the invention are disclosed in the following detailed description and the accompanying drawings.

FIG. 1 is a block diagram illustrating an embodiment of a video encoding system.

FIG. 2 is a flow chart illustrating an embodiment of a process for encoding a video using a codec.

FIG. 3 is a flow chart illustrating an embodiment of a process for propagating contributing relevance amounts for blocks of pixels in frames of a video being encoded.

FIG. 4 is a diagram illustrating examples where the portion of the reference frame that originates data for a particular pixel block of the current frame can be from zero to four pixel blocks of the reference frame.

FIG. 5 is a conceptual diagram illustrating an embodiment of lines in a cache used to store accumulated relevance amounts for pixel blocks of a frame of a video being encoded.

FIG. 6 is a flowchart illustrating an embodiment of a process for initializing and utilizing a circular cache to store accumulated relevance amounts for blocks of a reference frame.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Encoding a video often involves performing partitioning, motion estimation, quantization transformation, and entropy encoding. During quantization, different scaling (e.g., step-size) factors can be selected to control encoding bit-rate. Although selecting a large scaling factor will desirably reduce the size of the encoding, it will introduce a larger amount of distortion. Thus, carefully choosing the right scaling factor to balance bit-rate and distortion is critical in achieving the most efficient encoding. Different amounts of bits can be allocated to different frames of a video to achieve rate-distortion optimization. Additionally, not only can different amounts of bits be allocated to different frames, different bit allocation can be achieved on a per-block level by determining the optimal quantization factor for each block of pixels (e.g., macroblock). However, achieving this optimization is compute intensive, especially when encoding a frame is dependent upon multiple other frames.

In some embodiments, a hardware processor has been specifically designed (e.g., application specific integrated circuit (ASIC)) to perform video encoding. This hardware processor includes processing and cache optimizations to enable efficient performance of video encoding. In some embodiments, a processor system includes a block relevance determination hardware unit configured to determine a corresponding degree of relevance total metric of each block of pixels of a reference frame of a video being encoded including by propagating block level contributing relevance amounts from a dependent frame of the video to the reference frame. For example, in order to estimate a total relevance metric based on a relative amount of data that each pixel block (e.g., macroblock) of the reference frame contributes to the encoding of future frames, contributing relevance amounts for pixel blocks of video frames (e.g., macroblock tree costs) are propagated in reverse order of motion prediction (e.g., reverse of motion vectors) to accumulate relevance metrics and determine a corresponding total metric for degree of relevance of each block of pixels of each reference frame of the video. An encoder unit of the processor system is configured to encode the reference frame using a quantization factor determined based on the determined total metrics for degrees of relevance of blocks of the reference frame. For example, by knowing which block is more relevant as compared to another block, more bits can be allocated to the more relevant block during quantization. Additionally, the processor system includes a hardware circular cache unit having groups of cache entries, where each cache entry is configured to store corresponding accumulated relevance values for one or more different pixel blocks of the reference frame. This cache unit allows efficient handling data access by reducing cache and memory access penalties.

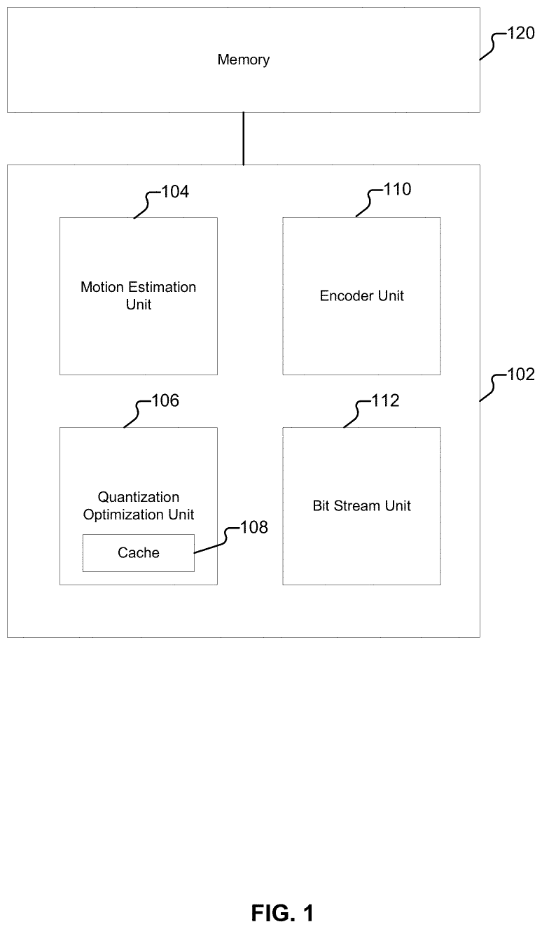

FIG. 1 is a block diagram illustrating an embodiment of a video encoding system. Video encoding hardware processor 102 (e.g., application specific integrated circuit (ASIC)) has been specifically configured to perform video encoding. Memory 120 includes system memory (e.g., general system memory) configured to store video data as well as any other data utilized in video encoding. For example, memory 120 is a part of a larger system memory shared by many other components (e.g., general purpose processor). Video encoding processor 102 may be included in a server or other computing device and a general purpose processor of the server/device may instruct video encoding processor 102 to perform encoding of a video. Processor 102 retrieves the video via memory 120 and also stores intermediate results and final encoded video via memory 120.

Video encoding processor 102 includes motion estimation unit 104, quantization optimization unit 106, encoder unit 110, and bit stream unit 112. Encoder unit 110 is configured to orchestrate and perform processing to encode a video based on a codec. The video includes a series of frames, and one way of compressing the video is to compress each frame individually, taking advantage of redundancies within each frame image (e.g., intra-frame compression). However, improved compression performance can be achieved by taking advantage of temporal redundancies across different frames of the video. A frame of the video can be encoded based on motion vectors that best describe spatial movement/displacement/transformation of blocks of pixels from a reference frame to another frame plus a determined residual difference that identifies differences not captured by the motion vectors. Finding the best motion vector and corresponding residual that results in the best compression is a complex task and motion estimation unit 104 is configured to perform motion estimation searches to calculate cost metrics for different candidate motion vectors and corresponding residual differences. These cost metrics can be compared (e.g., by encoder unit 110 or motion estimation unit 104) for different candidate motion vectors to identify the best motion vectors to utilize for the video encoding (e.g., ones that minimize corresponding residual differences).

Compression of a frame can be further improved by performing quantization to reduce the amount of data into a smaller set of discrete values. However, factors of the quantization are tunable to allow more or less data corresponding to more or less distortion. In some embodiments, by enabling quantization to be specified on a pixel block (e.g., block of pixels such as a macroblock) level of a frame, important pixel blocks of the frame (e.g., reference portion often utilized again in another frame) can be allowed more data to reduce distortion while other less important blocks of the frame can be allowed less data during encoding. Quantization optimization unit 106 includes a block relevance determination hardware unit configured to determine the corresponding degree of relevance metric of each block of pixels of a reference frame of a video being encoded including by propagating a block level contributing relevance amount from a dependent frame of the video to the reference frame. For example, in order to estimate the degree of relevance metric based on a relative amount of data that each pixel block (e.g., macroblock) of the reference frame contributes to the encoding of future frames, the contributing relevance amounts for pixel blocks of video frames are propagated in reverse order of motion prediction (e.g., reverse of motion vectors) to accumulate relevance amounts and determine a corresponding total metric for degree of relevance of each block of pixels of each reference frame of the video.

Quantization optimization unit 106 includes cache 108 configured as a circular cache having groups (e.g., lines) of cache entries, where each cache entry is configured to store corresponding accumulated relevance values for one or more different pixel blocks of a reference frame. Cache 108 allows efficient handling data access by reducing cache and memory access penalties. Cache 108 is a part of a memory/storage hierarchy. Memory 120 is part of this memory hierarchy, and data for a cache entry of cache 108 is loaded from memory 120 or evicted for updating back to memory 120. Encoder unit 110 is configured to quantize/transform a frame using corresponding quantization factors determined for different pixel blocks of the frame based on the corresponding degree of relevance metrics of the blocks determined by quantization optimization unit 106. Bit stream unit 112 is configured to further compress the quantized results by performing entropy encoding.

Components shown in FIG. 1 are merely examples and any number of shown components may be included in various embodiments. Other embodiments may include additional components or may not include one or more of the components shown in FIG. 1.

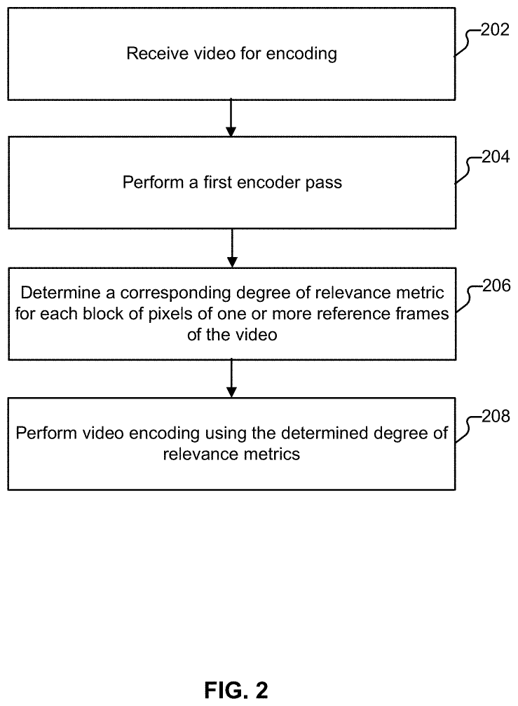

FIG. 2 is a flow chart illustrating an embodiment of a process for encoding a video using a codec. At least a portion of the process of FIG. 2 may be performed using one or more of the components shown in FIG. 1.

At 202, a video is received for encoding. In some embodiments, a general purpose hardware processor (e.g., central processing unit) of a system instructs a special purpose hardware component (e.g., ASIC configured to perform video encoding) to perform encoding of the video using a codec. The video includes frames of images and encoding the video may include further compressing the video, encoding the video to one or more different formats, and/or encoding the video to one or more different resolutions. For example, a user uploads a user generated video in a first format and the video is to be encoded to different formats for distribution to various different devices that each may desire different video formations or resolutions based on device type and available network bandwidth.

At 204, a first encoder pass is performed. The first encoder pass may include initially analyzing the video to determine pixel block size(s) to be utilized and groups of frames to be encoded together. For example, each frame is divided into a grid of pixel blocks, where each pixel block (e.g., macroblock) includes a group of pixels to be analyzed and processed together. The first encoder pass also includes performing motion estimation and search to determine motion vectors to be utilized as well as determine a video encoding frame type for each frame. For example, each frame within a group of frames to be encoded together is identified as an I-frame, P-frame, or B-frame to identify a type of encoding to be utilized for the frame. The I-frame is encoded only based on contents of itself (e.g., intra-coded framed) without relying on other frames within the group. The P-frame is encoded using data from a previous (reference) frame. The B-frame is encoded using data from both a previous (reference) frame and a forward (reference) frame. During the motion estimation/search, various values and metrics are calculated and these values and metrics are stored for later use during quantization optimization. For each pixel block, some of the metrics include a motion vector, an intra-mode cost (e.g., sum of absolute differences or sum of absolute transformed differences between original and intra-mode encoded frames), and inter-mode cost (e.g., sum of absolute differences or sum of absolute transformed differences between original and inter-mode encoded frames).

At 206, a corresponding degree of relevance metric is determined for each block of pixels of one or more reference frames of the video. For example, compression of a frame can be further improved by performing quantization to reduce the amount of data required to encode the frame into a smaller set of discrete values. However, factors of the quantization are tunable to allow more or less data corresponding to more or less distortion. For example, different scaling (e.g., step-size) factors can be selected to control encoding bit-rate. Different bit-rate allocation can be achieved on a per-block level by determining the optimal quantization factors for each block. In some embodiments, by enabling quantization to be specified on a pixel block level of a frame, important blocks of the frame (e.g., reference portion often utilized again in another frame) can be allowed more data to reduce distortion while other less important blocks of the frame can be allowed less data during encoding. In order to have a basis for determining the quantization factors, a degree of relevance metric is determined for each block of pixels of one or more frames of the video being encoded including by propagating block level component relevance values from pixel blocks of other dependent frame(s) (e.g., macroblock tree cost propagation performed). For example, in order to estimate the degree of relevance metric based on a relative amount of data that each pixel block (e.g., macroblock) of the reference frame contributes to the encoding of future frames, contributing relevance amounts for pixel blocks of video frames are propagated in reverse order of motion prediction (e.g., reverse of motion vectors) to accumulate relevance amounts and determine a corresponding degree of relevance metric of each block of pixels of each reference frame of the video.

In some embodiments, the corresponding degree of relevance metric for a particular pixel block of a reference frame is calculated based on the accumulated relevance amount stored for the pixel block during back propagation of contributing relevance amounts from analysis of blocks of other frame(s) that are based on the particular pixel block of the reference frame. For example, the stored result of the accumulated relevance amount for a particular pixel block is obtained from storage (e.g., via cache 108 of FIG. 1) and used in a calculation (e.g., calculation performed also using intra-mode cost and inter-mode cost for the particular pixel block) to determine the corresponding degree of relevance metric for the particular pixel block.

At 208, video encoding is performed using the determined degree of relevance metrics. The corresponding degree of relevance metric may be used to determine a quantization parameter/factor for each pixel block of a frame. For example, a higher bit-rate quantization parameter/factor (e.g., smaller scaling/step-size factor) can be allocated to a block with a higher degree of relevance metric, while a lower bit-rate quantization parameter/factor (e.g., larger scaling/step-size factor) can be allocated to a block with a lower degree of relevance metric. Based on the determined degree of relevance metrics that identify relative importance of each of the pixel blocks of a frame, a corresponding target budget for the amount of bits (e.g., a bit-rate budget) to be allocated for encoding each of the pixel blocks can be determined. Then based on the corresponding determined target budget, a corresponding quantization parameter/factor that gives a best trade-off between controlling rate and overall quality can be determined for the corresponding pixel block. For example, the relative differences between different corresponding degree of relevance metrics for different pixel blocks of the frame can be used to allocate different component bit-rate budgets that are used to determine different quantization factors for different pixel blocks of the frame. In some embodiments, these determined block level quantization parameters/factors are used to quantize the frames of the video. After quantization, the entropy encoding is able to be applied to further compress the video and output final encoded frames/video.

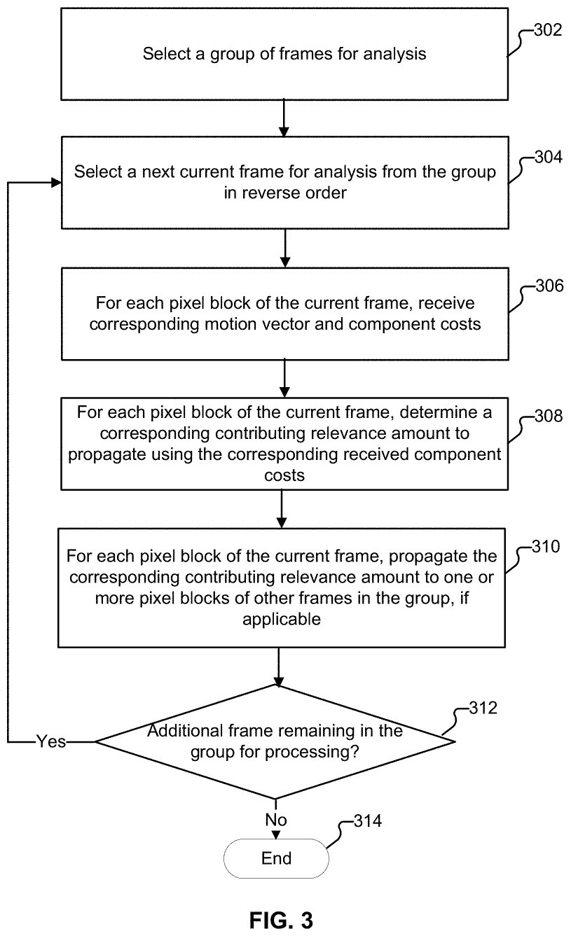

FIG. 3 is a flow chart illustrating an embodiment of a process for propagating contributing relevance amounts for blocks of pixels in frames of a video being encoded. The process of FIG. 3 may be performed using one or more of the components shown in FIG. 1. In some embodiments, at least a portion of the process of FIG. 3 is performed in 206 of FIG. 2 in determining the degree of relevance metrics for pixel blocks of frames.

At 302, a group of frames in a video being encoded is selected for analysis. There may exist a plurality of groups of frames in the video and a different group of frames is selected for analysis during different iterations of the process of FIG. 3. For example, the process of FIG. 3 is repeated for each different group of frames. The group may be a group of pictures and includes successive frames within the video that can be dependent or based on another frame within the same group during encoding, whereas frames in different groups are not dependent on one another during encoding. Each frame within the group may be identified as an I-frame, P-frame, or a B-frame to specify any encoding dependency with another frame within the group. I-frame specifies that the frame is coded independently without dependency to another frame (e.g., first frame in the group). P-frame specifies that the frame is coded based on a previous frame (e.g., encoded as a motion-compensated difference relative to a previous frame). B-frame specifies that the frame is coded based on a previous frame and/or a future frame (e.g., encoded as a motion-compensated difference relative to a previous frame and a next frame in the video).

At 304, a next current frame for analysis is selected from the group in reverse order (e.g., reverse motion estimation processing order). For example, frames in the group have been analyzed in chronological order (i.e., from earliest to latest) during motion estimation to determine motion vectors identifying interdependencies between frames, but to determine degree of relevance metrics, the frames in the group are analyzed in reverse order (e.g., reverse chronological order from latest to earliest) to trace dependencies back to the source pixel blocks. This reverse tracing of dependencies backwards enables determination of the degree a particular pixel block of a frame serves as a source/basis for other pixel block(s) in other frame(s). The next current frame in a first iteration of 304 is the last frame in the currently selected group of frames. In some embodiments, for each subsequent iteration of 304, the next current frame is set as a frame previous in chronological order to the previous current frame selected for analysis.

At 306, for each block of pixels (i.e., pixel block) of the current frame, a corresponding motion vector and component costs are received. Each frame is divided into a grid of different pixel blocks (e.g., macroblocks), and pixels in a pixel block are processed together as a unit. In some embodiments, during a first encoder pass, motion estimation was performed and a motion vector has been identified for each pixel block in the current frame (e.g., dependent adjacent frame) to represent the pixel block based on a portion of another frame (i.e., reference frame) located at a location offset specified by the motion vector. By following the motion vectors, data dependencies between portions of different frames can be discovered. The received component costs include values that can be used to approximate an amount of information that a particular block has obtained from different frame(s) due to motion estimation.

In some embodiments, during motion estimation, determining and selecting a motion vector for a pixel block includes determining an intra-mode cost (e.g., amount of data/bits required to encode the pixel block if intra-mode encoding as I-frame based only on the current frame without referencing other frames) and an inter-mode cost (e.g., amount of data/bits required to encode the pixel block if inter-mode encoding as P-frame or B-frame based on referencing other frame(s)), and these costs are retained from motion estimation for use during the process of FIG. 3. An example of an intra-mode cost included in the received costs includes a sum of absolute differences (SAD) intra-mode cost or a sum of absolute transformed differences (SATD) intra-mode cost. An example of an inter-mode cost included in the received component costs includes a sum of absolute differences (SAD) inter-mode cost or a sum of absolute transformed differences (SATD) inter-mode cost.

If applicable, the received component costs for a pixel block also include an accumulated relevance amount (e.g., accumulation of propagated amount of how much information each of its pixel blocks contributes to prediction of other frame(s)). For example, there would be no accumulated relevance amount for pixel blocks of the last frame of the selected group of frames being analyzed (e.g., first frame to be analyzed from the group for propagation) because no other frame depends on it for coding. However, as other frames in the group are analyzed in reverse motion estimation order, contributing relevance amounts based on the corresponding amount of information each pixel block of each current frame being analyzed contributes to a prediction of another frame are propagated back to the source pixel blocks as different chains of interdependencies across different pixel blocks of different frames are traced back with each subsequent frame being analyzed in the group. Thus not only does an amount of information a pixel block of one frame contributes to another frame dependent on its immediate contribution to an immediate future frame, it also depends on how the data gets further propagated in additional future frames. A storage can track and update a corresponding accumulated relevance amount for each pixel block of frames in the group (e.g., accumulated approximation of how much information the block contributes to prediction of other frame(s)) with each new pixel block and new current frame being analyzed in the group for contributing relevance amount propagation.

At 308, for each pixel block of the current frame (e.g., dependent frame), a corresponding contributing relevance amount to propagate is determined using the corresponding received component costs. In some embodiments, the corresponding contributing relevance amount to propagate is a measure of how much information of the particular block in the current frame is referenced from a different frame. Not only does the corresponding contributing relevance amount depend on the received intra-mode cost, it also depends on the received accumulated relevance amount for the particular block of the current frame. For example, the intra-mode cost and the received accumulated propagated relevance metric are summed in determining the contributing relevance amount for a pixel block. However, because the pixel block of the particular frame may not have been entirely sourced from a different frame, this sum is scaled (i.e., multiplied) by a fractional scalar approximating the proportional amount of data the particular pixel block of the current frame has sourced from other frame(s) to determine the corresponding contributing relevance amount to propagate for the particular pixel block. Based on a rough approximation that the intra-mode cost and the inter-mode cost approximate the amount of data not attributable to the selected mode, this fractional scalar can be determined based on a ratio between the received intra-mode cost and the received inter-mode cost (e.g., 1-intra-mode cost/inter-mode cost), where the inter-mode cost is set as the intra-mode cost if the inter-mode cost is greater than the intra-mode cost (e.g., intra-mode selected if it costs less).

At 310, for each pixel block of the current frame (e.g., dependent frame), the corresponding contributing relevance amount is propagated to one or more pixel blocks of one or more other reference frames in the group, if applicable. For example, a corresponding motion vector for a particular pixel block of the current frame identifies a portion of a different frame (e.g., reference frame) where data of at least a portion of the particular pixel block of the current frame can be sourced. Propagating the contributing relevance amount includes using this amount to update (e.g., add to) the accumulated relevance amount for the one or more pixel blocks corresponding to one or more portions of one or more different reference frames identified by the corresponding motion vector(s). The propagation is based on an identified frame type of the current frame. Propagation is not needed if the current frame is an I-frame. Propagation is to a previous frame in time if the current frame is a dependent P-frame. Propagation is to both a previous frame and a forward frame if the current frame is a dependent B-frame. In some embodiments, for a B-frame to enable more efficient memory handling, propagation to one frame (e.g., previous frame) is performed and completed before propagation to the other frame (e.g., forward frame).

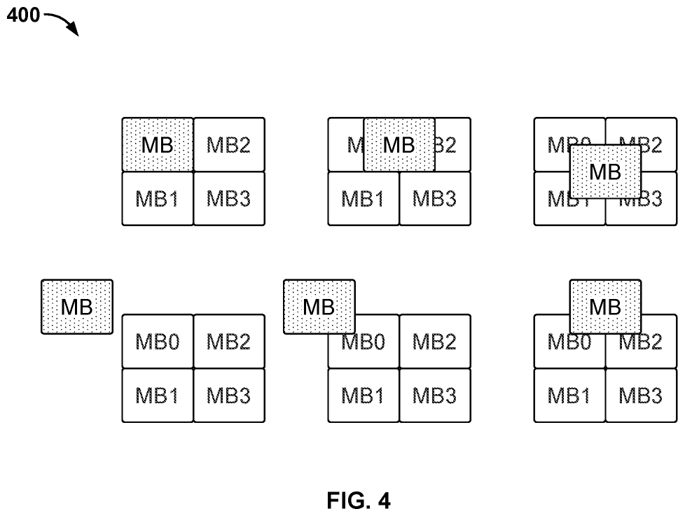

In some embodiments, the corresponding contributing relevance amount to propagate for a particular block of the current frame is split (e.g., equally or weighted) among all of the other originating pixel blocks of other reference frame(s) where the particular block's data has been sourced (e.g., blocks of reference frame(s) used in motion estimation/prediction of the particular block of the current frame). These originating pixel blocks may be from a plurality of reference frames (e.g., for a B-frame) and/or from multiple pixel blocks of a same reference frame. For example, a portion of a reference frame that originates data (e.g., referenced by a motion vector) for a particular pixel block of the current frame can straddle multiple pixel blocks of the reference frame. FIG. 4 is a diagram illustrating examples where the portion of the reference frame that originates data (e.g., referenced by a motion vector) for a particular pixel block of the current frame can be from zero to four pixel blocks of the reference frame. Diagram 400 shows that one block (e.g., labeled “MB”) of a current frame can be originated/estimated from a maximum of four blocks of a reference frame (e.g., labeled “MB0,” “MB1,” “MB2,” “MB3”). The six possible scenarios where one block of the current frame can be originated/estimated from a zero, one, two or four pixel blocks of the reference frame are shown in diagram 400.

The corresponding split portion of the corresponding contributing relevance amount to propagate is added to the corresponding accumulated relevance amount for the corresponding pixel block(s) of the reference frame(s). The fractional proportion of contributing relevance amount split among the different pixel block(s) of the reference frame(s) may be based on a corresponding determined weight (e.g., prediction or motion estimation weighting) and/or size proportion within the pixel block of the reference frame that originates data for the particular block of the current frame.

In some embodiments, a hardware cache designed to improve performance is utilized to cache and update the accumulated relevance amount of pixel blocks of reference frames. This cache includes enough cache entry groups (e.g., cache lines) to store the accumulated relevance amount values for blocks of a reference frame that are reachable by motion vectors of a current row of pixel blocks of the current frame being analyzed. This allows any update of the accumulated relevance amount for pixel blocks of the reference frame from the current row of blocks of the current frame to hit the cache rather than requiring a read and update to slower main memory. The hardware cache is also configured to prefetch accumulated relevance amounts for a next row of pixel blocks of the reference frame into the cache while the cache is being used to propagate contributing relevance amounts for the current row of pixel blocks of the current frame so that the prefetched accumulated relevance amounts for the next row can be used when the current row of blocks of the current frame being analyzed advances to a next current row of blocks of the current frame. In some embodiments, each single entry of the hardware cache includes data (e.g., the accumulated relevance amounts) for a plurality of consecutive pixel blocks of the reference frame. This allows more efficient updating of the accumulated relevance amount in the event a motion vector for a particular block of the current frame identifies a reference portion of a reference frame that straddles multiple pixel blocks of the reference frame. The accumulated relevance amounts for both of these straddled blocks of the reference frame need to be updated, and by having a single cache entry that stores amounts for both these straddled pixel blocks of the reference frame, only a single update to this cache entry is needed to update both accumulated relevance amounts rather than requiring two separate updates.

At 312, processing for the current frame has concluded and it is determined whether any additional frame is left in the group of processing. If it is determined that an additional frame is left in the group of processing, the process returns to 304, where a next current frame from the group is selected. If it is determined that no additional frame is left in the group of processing, the process ends at 314.

In some embodiments, after processing for all of the frames of the group has finished in 314, a corresponding degree of relevance metric is determined for each pixel block of each frame in the group based on the total accumulated relevance amount stored for the corresponding pixel block. For example, the stored result of the accumulated relevance amount for a particular pixel block is obtained from storage (e.g., via cache 108 of FIG. 1) and used in a calculation (e.g., calculation performed also using intra-mode cost and inter-mode cost for the particular pixel block of the frame) to determine the corresponding degree of relevance metric for the particular pixel block.

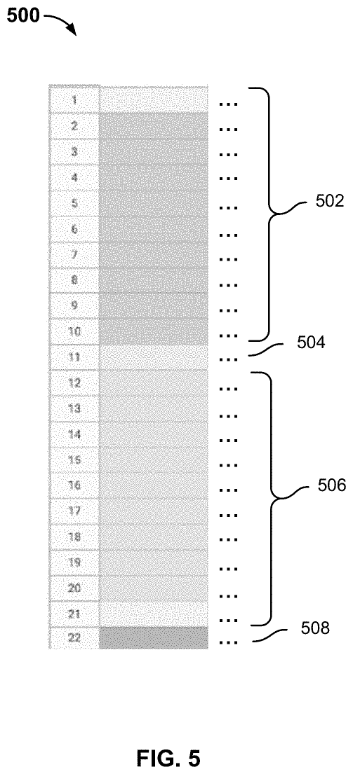

FIG. 5 is a conceptual diagram illustrating an embodiment of lines in a cache used to store accumulated relevance amounts for pixel blocks of a frame of a video being encoded. In some embodiments, the cache shown in FIG. 5 is included in cache 108 of FIG. 1. In some embodiments, the cache shown in FIG. 5 is utilized in 310 of FIG. 3 to retrieve and update accumulated relevance amounts for pixel blocks of a reference frame during contributing relevance amount propagation.

Cache 500 includes 22 cache lines. Each line includes a plurality of cache entries. Each line of cache 500 corresponds to a row of blocks in a reference frame and includes enough entries to store accumulated relevance amounts for the entire row of blocks in a reference frame. Row 504 corresponds to a same row location of blocks of a reference frame as a current row location of blocks of a current frame being processed (e.g., during the process of FIG. 3).

When propagating a contributing relevance amount for a block in the currently processing row of pixel blocks of the current frame, its motion vector is used to identify source pixel block(s) of a reference frame for which its accumulated relevance amount is to be updated. However, a range of pixel blocks of a reference frame that are able to be referenced by a motion vector of a particular block in the current frame is limited in range (e.g., according to an encoding codec standard). For example, a motion vector is limited to reference a portion of a frame that is within 10 pixel block rows up and 10 pixel block rows down from a current pixel block row number of the particular block in the current frame (e.g., motion vector constrained to only reference a portion of a reference within a relative horizontal range of −512 to 512 pixels and a relative vertical range of −160 to 160 pixels). Thus by having a cache that is at least as large to capture this range ensures that the reading and updating of the accumulated relevance amount for pixel blocks of the reference frame within the possible range is capable of being handled by the cache. In one example, when pixel block row number 11 is being analyzed in the current frame, any motion vector of any block in this row 11 of the current frame is only allowed to reference a portion of the reference that is within a range limit (e.g., within plus or minus 10 pixel block rows) from its corresponding position in the reference frame. In one example, Cache 500 shows that when a pixel block row is being analyzed in the current frame, accumulated relevance amounts for its positionally matching pixel block row in the reference frame are stored in cache line 504. Cache lines 502 store accumulated relevance amounts for pixel block rows in the reference frame spanning an upper motion vector reach limit above the row corresponding to cache line 504, and cache lines 506 store accumulated relevance amounts for pixel block rows in the reference frame spanning a lower motion vector reach limit below the row corresponding to cache line 504.

Cache 500 is a circular cache. Although values in cache entries can be individually updated (e.g., to update accumulated relevance amount by adding to it a scaled contributing relevance amount) in any order and position for any accumulated relevance amount representing the same pixel block, groups of cache entries (e.g., cache lines) are replaced in circular order within the cache when being replaced to represent a different pixel block of the reference frame (e.g., ordering of cache entries wraps around in circular order within the cache and oldest cache entries are replaced first to represent a next pixel block). For example, when a rotation is triggered (e.g., due to next row of pixel blocks of the current frame being processed), a group of cache entries storing accumulated relevance amounts for the beginning most row of pixel blocks of the reference frame (e.g., oldest cache line) is replaced with new values corresponding to a next row of pixel blocks in prefetch order (e.g., replacement accumulated relevance amounts are for a next row of pixel blocks of the reference frame after the row of pixel blocks of the reference frame of a previously replaced cache line). In the example shown, cache line 508 is used in prefetching accumulated relevance amounts for a next row of pixel blocks of the reference frame so that the cache is ready when analysis of the process of FIG. 3 moves on to a next pixel block row of the current frame. Any previously stored accumulated relevance amounts in cache line 508 are evicted and written back to main memory for storage.

When an entire pixel block row of a current frame has been analyzed and the analysis moves on to the next block row of the current frame, a next cache line is selected as the cache line corresponding to the current pixel block row being analyzed. For example, cache line 12 of cache 500 becomes the new cache line corresponding to the current block row, cache lines 2-11 become the lines within the upper range of the motion vector reach limit, cache lines 13-22 become the lines within the lower range of the motion vector reach limit (e.g., cache line 22 includes prefetched accumulated relevance amounts for the next row of the reference frame after the row corresponding to cache line 21), and amounts in cache line 1 are evicted and written back to memory to store cache line 1 prefetched accumulated relevance amounts for a next row of pixel blocks of the reference frame (e.g., next row after the row corresponding to cache line 22).

In some embodiments, the entries in the cache lines of cache 500 include data (e.g., the accumulated relevance amounts) for a plurality of consecutive pixel blocks (e.g., 8 pixel blocks) of the reference frame. This allows more efficient reading and updating of the accumulated relevance amounts. For example if a motion vector for a particular block of the current frame identifies a reference portion of a reference frame that is included multiple pixel blocks of the reference frame and a single cache entry stores data for these multiple pixel blocks of the reference frame, only a single update to this cache entry is needed to update both values rather than requiring two separate updates to two different cache entries.

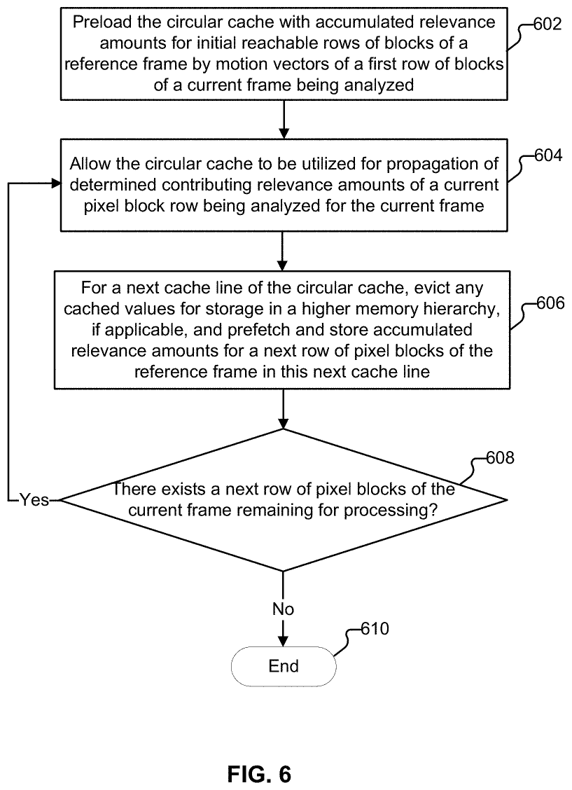

FIG. 6 is a flowchart illustrating an embodiment of a process for initializing and utilizing a circular cache to store accumulated relevance amounts for blocks of a reference frame. In some embodiments, the circular cache described in FIG. 6 is cache 108 of FIG. 1 and/or cache 500 of FIG. 5. In some embodiments, at least a portion of the process of FIG. 6 is utilized to manage a cache utilized in 310 of FIG. 3 to retrieve and update accumulated relevance amounts for pixel blocks of a reference frame during contributing relevance amount propagation.

At 602, the circular cache is preloaded with accumulated relevance amounts for initial reachable rows of blocks of a reference frame by motion vectors of a first row of blocks of a current frame being analyzed. For example, when the circular cache is to be utilized for a new reference frame, the circular cache is initialized for the new reference frame by being loaded with accumulated relevance amounts for rows of pixel blocks of the reference frame within a motion vector reach limit (e.g., specified by a video encoding codec standard supported by processor 102 of FIG. 1) for a first row of pixel blocks of a current frame being analyzed for propagation of contributing relevance amounts (e.g., using the process of FIG. 3). For example, according to a codec, a motion vector is only able to reference a portion of a reference frame within a relative maximum range (e.g., only allowed to reference a portion of a reference frame that is within 10 pixel block rows up and 10 pixel block rows down from a corresponding position in the current frame), and given that there are no rows above the first row of pixel blocks, accumulated relevance amounts for the first 11 rows (i.e., current row plus the 10 rows down range) of the reference frame are loaded into the cache entries of the first 11 cache entry groups (e.g., 11 cache lines) of the circular cache. Each cache line included enough entries to store accumulated relevance amounts for every pixel block of a particular pixel row of a reference frame.

At 604, the circular cache is allowed to be utilized for propagation of determined contributing relevance amounts of a current pixel block row being analyzed for the current frame. The current pixel block row of the current frame is the first row of pixel blocks of the current frame during a first iteration of 604, and the pixel block row identified as the current pixel block row advances to a next pixel block row upon each subsequent iteration of 604. Because the circular cache has been specifically sized to store accumulated relevance amounts for all blocks of the reference frame that are within the reach limit of motion vectors of a current row of blocks of a current frame, propagation of the contributing relevance amounts can be performed at the level of the circular cache without a cache miss. In some embodiments, entries in the cache line each store accumulated relevance amounts for a plurality of consecutive pixel blocks of the reference frame (e.g., each entry stores accumulated relevance amounts for 8 consecutive pixel blocks), enabling only a single write to preload the cache with these accumulated relevance amounts and also enabling only a single write to one cache entry to update a plurality of accumulated relevance amounts for two consecutive pixel blocks at once.

At 606, for a next cache line of the circular cache, any cached values are evicted for storage in a higher memory hierarchy, if applicable, and accumulated relevance amounts for a next row of pixel blocks of the reference frame are prefetched and stored in this next cache line. For example, while a current row of pixel blocks of the current frame is being analyzed for contributing relevance amount propagation, an extra cache line currently not storing accumulated relevance amounts reachable by any motion vector of the current row of pixel blocks of the current frame being analyzed can be used to preload from the memory hierarchy (e.g., system memory 120 of FIG. 1) the accumulated relevance amounts for the next row of pixel blocks of the reference frame not yet stored/prefetched into the circular cache. Because the cache is a circular cache, this next cache line (e.g., oldest cache line in the cache) may include updated accumulated relevance amounts that needed to be written back to the memory hierarchy (e.g., into main system memory 120 of FIG. 1) when being evicted from the cache to make room for the accumulated relevance amounts of the next row of blocks of the reference frame. In some embodiments, entries in the cache line each store accumulated relevance amounts for a plurality of consecutive blocks of the reference frame, allowing a reduction in the number of entries that need to be read from or written back to main memory in the storage hierarchy as compared to each cache entry storing only one amount for one pixel block. By having this separate additional cache line outside of the reach range limit of motion vectors of the current row of pixel blocks of the current frame, cache eviction and prefetching can take place while other cache lines storing amounts within the reach range limit can be used currently during contributing relevance amount propagations for the current row of blocks of the current frame being analyzed.

At 608, it is determined whether there exists a next row of pixel blocks of the current frame remaining for processing. For example, upon detecting completion of analysis and contributing relevance amount propagation for the entire current row of pixel blocks of the current frame, it is determined whether there exists a next row of pixel blocks of the current frame remaining for analysis and contributing relevance amount propagation (e.g., completed current row of pixel blocks of the current frame is not the last row of blocks of the current frame). If at 608 it is determined that there exists an additional next row of pixel blocks of the current frame remaining, the process proceeds to 604 where the row of pixel blocks of the current frame designated as the current pixel block row of the current frame advances to a next row of pixel blocks for analysis and propagation of corresponding determined contributing relevance amounts. Thus each iteration of the process from 604 to 608 allows the circular cache to support updating of the accumulated relevance amount for each successive row of pixel blocks of the current frame analyzed for contributing relevance amount propagation. If at 608 it is determined that there does not exist an additional next row of pixel blocks of the current frame remaining, the process ends at 610 (e.g., by flushing out any remaining cache lines out for storage in a higher memory hierarchy). The process of FIG. 6 may then be repeated for another reference frame of the current frame and/or repeated for a next current frame.

Although the foregoing embodiments have been described in some detail for purposes of clarity of understanding, the invention is not limited to the details provided. There are many alternative ways of implementing the invention. The disclosed embodiments are illustrative and not restrictive.

What Is Claimed Is:

1. A processor system, comprising:
A block relevance determination hardware unit configured to determine a corresponding degree of relevance metric for each block of pixels included in blocks of pixels of a reference frame of a video being encoded including by being configured to propagate corresponding block level contributing relevance amounts determined for blocks of pixels of a dependent frame of the video to one or more corresponding ones of accumulated relevance amounts for the blocks of pixels of the reference frame, wherein the corresponding degree of relevance metric is based on a relative amount of data that a block of pixel of the reference frame contributes to encoding of future frames;
a hardware circular cache configured to store groups of cache entries, wherein each cache entry of each group of the groups of cache entries is configured to cache at least one corresponding one of the accumulated relevance amounts for the blocks of pixels of the reference frame; and
an encoder hardware unit configured to encode the reference frame using different quantization factors determined for a different block of pixels of the reference frame based on the corresponding degree of relevance metric.

2. The system of claim 1, wherein the block relevance determination hardware unit, the hardware circular cache, and the encoder hardware unit are included in a same application-specific integrated circuit chip.

3. The system of claim 1, wherein each cache entry of the cache entries is configured to store a plurality of ones of the accumulated relevance amounts for multiple blocks of pixels of the reference frame.

4. The system of claim 1, wherein the hardware circular cache is sized to include enough cache entries to cache ones of the accumulated relevance amounts for at least ones of the blocks of pixels of the reference frame within motion vector range limits for motion vectors of a row of blocks of pixels of the dependent frame.

5. The system of claim 1, wherein the blocks of pixels of the reference frame include macroblocks of the reference frame.

6. The system of claim 1, further comprising a motion estimation hardware unit configured to perform a motion estimation search to calculate cost metrics utilized in determining the corresponding degree of relevance metrics.

7. The system of claim 1, wherein the corresponding block level contributing relevance amounts are determined using corresponding cost metrics determined using a previous encoder pass of frames of the video.

8. The system of claim 7, wherein the corresponding cost metrics were stored in a memory during the previous encoder pass for later use by the block relevance determination hardware unit.

9. The system of claim 1, wherein each of the corresponding degree of relevance metrics is determined based on a corresponding one of the accumulated relevance amounts.

10. The system of claim 1, wherein the different quantization factors include different scaling or step-size factors.

11. The system of claim 1, wherein the dependent frame is included in a group of frames analyzed in reverse chronological order for contributing relevance amount propagation processing.

12. The system of claim 1, wherein the corresponding block level contributing relevance amounts are determined using corresponding motion vectors, corresponding intra-mode costs, and corresponding inter-mode costs.

13. The system of claim 1, wherein the corresponding block level contributing relevance amounts are determined using corresponding accumulated relevance amounts of the blocks of pixels of the dependent frame.

14. The system of claim 1, wherein propagating the corresponding block level contributing relevance amounts to the one or more corresponding ones of the accumulated relevance amounts for the blocks of pixels of the reference frame includes identifying a specific motion vector for a specific block of pixels of the dependent frame, identifying one or more of the blocks of pixels of the reference frame that include a portion of the reference frame referenced by the specific motion vector, and distributing a specific block level contributing relevance amount of the specific block of pixels of the dependent frame to the identified one or more of the blocks of the pixels of the reference frame.

15. The system of claim 1, wherein propagating the corresponding block level contributing relevance amounts to the one or more corresponding ones of the accumulated relevance amounts for the blocks of pixels of the reference frame includes splitting a specific block level contributing relevance amount into a plurality of different portions, and adding different ones of the plurality of the different portions to different accumulated relevance amounts cached in the hardware circular cache.

16. The system of claim 1, wherein propagating the corresponding block level contributing relevance amounts to the one or more corresponding ones of the accumulated relevance amounts for the blocks of pixels of the reference frame includes splitting a specific block level contributing relevance amount into at least two different portions for different blocks of pixels for two different reference frames.

17. The system of claim 1, wherein the hardware circular cache is configured to advance an identifier of a current cache line corresponding to a current row position of a current row of the blocks of pixels of the dependent frame being processed in response to an advancement of the current row of the blocks of pixels of the dependent frame being processed.

18. The system of claim 1, wherein the hardware circular cache is configured to prefetch into an oldest cache line, accumulated relevance amounts for a row of the blocks of pixels of the reference frame.

19. A method, comprising:
determining a corresponding degree of relevance metric for each block of pixels included in blocks of pixels of a reference frame of a video being encoded including by propagating corresponding block level contributing relevance amounts determined for blocks of pixels of a dependent frame of the video to one or more corresponding ones of accumulated relevance amounts for the blocks of pixels of the reference frame, wherein each cache entry of each group of groups of cache entries in a hardware circular cache caches at least one corresponding one of the accumulated relevance amounts for the blocks of pixels of the reference frame, wherein the corresponding degree of relevance metric is based on a relative amount of data that a block of pixel of the reference frame contributes to encoding of future frames; and
encoding the reference frame using different quantization factors determined for a different block of pixels of the reference frame based on the corresponding degree of relevance metric.

20. An integrated circuit device, comprising:
a block relevance determination portion configured to determine a corresponding degree of relevance metric for each block of pixels included in blocks of pixels of a reference frame of a video being encoded including by being configured to propagate corresponding block level contributing relevance amounts determined for blocks of pixels of a dependent frame of the video to one or more corresponding ones of accumulated relevance amounts for the blocks of pixels of the reference frame, wherein the corresponding degree of relevance metric is based on a relative amount of data that a block of pixel of the reference frame contributes to encoding of future frames;
a circular cache portion configured to store groups of cache entries, wherein each cache entry of each group of the groups of cache entries is configured to cache at least one corresponding one of the accumulated relevance amounts for the blocks of pixels of the reference frame; and
an encoder portion configured to encode the reference frame using different quantization factors determined for a different block of pixels of the reference frame based on the corresponding degree of relevance metric.
